(19) United States
(12) Patent Application Publication
(10) Pub. No.: US 2007/0289853 A1
(43) Pub. Date: Dec. 20, 2007

(54) Tailoring of switch bubble formation for LIMMS devices

(76) Inventors: Timothy Beerling, San Francisco, CA (US); Ashish Tandon, Sunnyvale, CA (US); Atul Goel, Fort Collins, CO (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/453,166

(22) Filed: Jun. 14, 2006

(51) Int. Cl. H01H 29/00

(52) U.S. Cl. 200/182

(57) ABSTRACT

Embodiments of the invention provide for improved separation of switching material by creating a diversion of the activating force. In one embodiment at least one structural element is positioned in close proximity to an inlet for the actuating force to influence the actuating force to fully separate the switching material. Structural elements may include protrusions, either adjacent to the inlet or approximately across the channel from the inlet, as well as at least one additional inlet. The diversion can be created, if desired, by forces coming from opposite sides. Embodiments of the invention make use of non-wettable surfaces lining the channel in regions where switching material is to break into separate volumes, and wettable surfaces away from such regions. Embodiments of the invention provide for multi-pole, multi-throw switching.

### CROSS-REFERENCE TO RELATED APPLICATION

The present application is related to commonly assigned U.S. patent application Ser. No. 11/399,644, Attorney Docket No. 10051238-1, filed on Apr. 6, 2006 entitled “ARCHITECTURE FOR MULTI-THROW MICRO-FLUIDIC DEVICES” the disclosure of which is hereby incorporated herein by reference.

### FIELD

This disclosure relates generally to liquid-based switching of electrical and optical signals, and more particularly, to improving the switching characteristics of a liquid-based switch.

### BACKGROUND

Liquid-based switches, such as liquid metal micro switches (LIMMS) have been made that use a liquid metal, such as mercury, as switching material. The liquid metal provides an electrical path in a channel between electrical contacts if there is a continuous volume of liquid metal between the contacts. If, however, the liquid metal is separated into two different volumes that are not touching, the electrical path between the electrical contacts will be open. Alternately, a LIMMS may use an opaque liquid to open or block light paths. To change the state of the switch, actuating force is applied to the switching material to cause one volume of the switching material to either join with or separate from another volume of switching material. The force must be sufficient to overcome the surface tension and wetting forces of the liquid used as the switching material.

The actuating force used to move volumes of switching material may come from the pressure of a heated gas. A problem may exist when heated gas is trying to work on the switching material and the chamber geometry is such that the gas cannot separate the material into separate slugs. As a result, some switching material may remain as a bridge between the two volumes, and the electrical contact is not broken.

### BRIEF SUMMARY OF THE INVENTION

Embodiments of the invention provide for improved separation of switching material by creating a diversion of the activating force. In one embodiment at least one structural element is positioned in close proximity to an inlet for the actuating force to influence the actuating force to fully separate the switching material. Structural elements may include protrusions, either adjacent to the inlet or approximately across the channel from the inlet, as well as at least one additional inlet. The diversion can be created, if desired, by forces coming from opposite sides. Embodiments of the invention make use of non-wettable surfaces lining the channel in regions where switching material is to break into separate volumes, and wettable surfaces away from such regions. Embodiments of the invention provide for multi-pole, multi-throw switching.

### BRIEF DESCRIPTION OF THE DRAWINGS

For a more complete understanding of the present invention, reference is now made to the following descriptions taken in conjunction with the accompanying drawings, in which:

FIG. 1 shows a prior art LIMMS;

FIG. 2 shows a first embodiment of an improved LIMMS device;

FIG. 3 shows a second embodiment of an improved LIMMS device; and

FIG. 4 shows a third embodiment an improved LIMMS device.

### DETAILED DESCRIPTION OF THE INVENTION

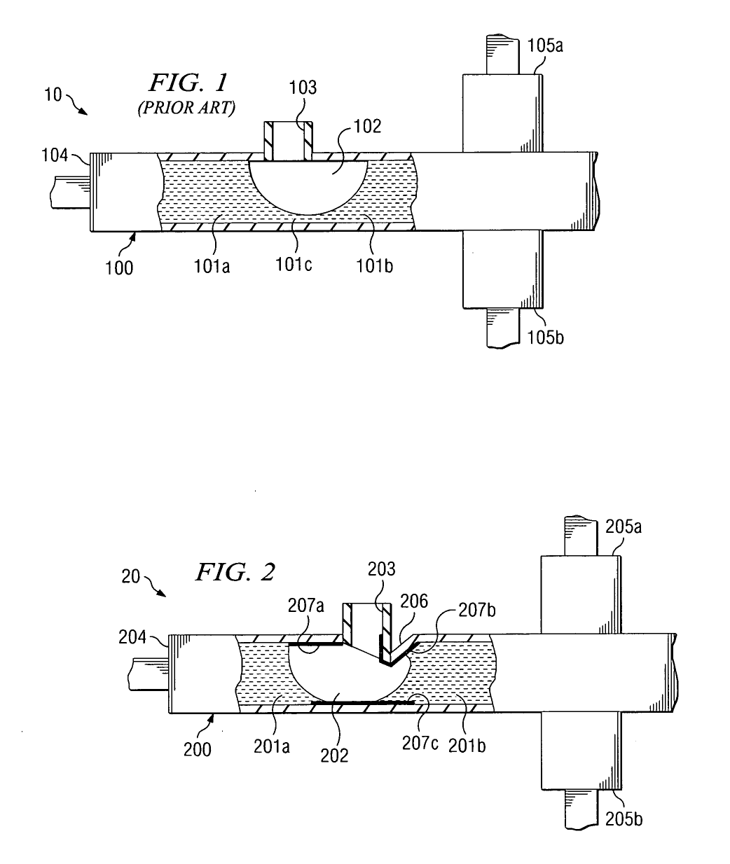

FIG. 1 shows prior art LIMMS device 10, comprising channel 100 and inlet 103. Electrical contacts may be at end walls 105a, 105b and 104. Switching material 101 is in two volumes, 101a and 101b, but with bridge volume 101c joining volumes 101a and 101b. Bridge volume 101c exists because actuating force 102, possibly provided by a heated gas from inlet 103, cannot fully split the two volumes 101a and 101b. Because of volume 101c there is electrical continuity in the switch and the switch does not open as discussed above.

FIG. 2 shows LIMMS device 20, arranged according to an embodiment of the invention. Device 20 comprises channel 200, inlet 203, and perturbation 206. Electrical contacts may be at end walls 205a, 205b and 204. Switching material 201 is in two volumes, 201a and 201b. The “notch”, or wall perturbation 206, adjacent to inlet 203, positively influences how actuating force 202 acts on the liquid metal, thereby separating volumes 201a and 201b, unlike what occurred in prior art device 10, as shown in FIG. 1. Notch 206 forces the heated gas bubble to remain more contained near inlet 203, because the surface tension of the liquid and contact angle of the liquid will not allow the heated gas bubble to grow beyond the notch. In one embodiment, notch 206 forms a 90° contact angle with the walls of bubble 202. This localization of the heated gas bubble makes it easier for the gas bubble to span across the channel thereby splitting the liquid into volumes 201a and 201b.

Actuating force 202 may be provided by heated gas available at inlet 203. Inlet 203 could provide a reservoir for the gas, such that when the gas is unheated it is at pressure equilibrium, and will not try to do work on the liquid in channel 200. Channel 200 may contain linings of non-wettable surfaces 207a, 207b and 207c, with wettable surfaces elsewhere in the channel. The use of non-wettable surfaces 207 near inlet 203, and wettable surfaces elsewhere, assists with breaking the liquid of switching material 201 into separate slugs.

FIG. 2 shows a section of a single-pole, double-throw switch and FIG. 5 shows, in schematic form, an overview of the full switch having heating element 51 which operates to create actuating force 202 which separates liquid metal volume 201a from liquid metal volume 201b. As shown in FIG. 5, heater 52 operates to create an actuating force (not shown because heater 52 is not enabled in FIG. 5) to selectively separate liquid metal volume 501 from liquid metal volume 201b to cut off (when heater 52 is activated) electrical signal flow to terminal 500. Note that when heater 52 is activated and heater 51 is not activated, volumes 201b and 501 will separate and volumes 201b and 201a will reunite so that electrical signals can pass between terminals 205a, 205b and 200, instead of passing between terminals 205a, 205b and 500. However, embodiments of the switch include multi-pole, multi-throw switches as shown, for example, in the above-identified copending application commonly assigned U.S. patent application Ser. No. 11/399,644, Attorney Docket No. 10051238-1, filed on Apr. 6, 2006 entitled “ARCHITECTURE FOR MULTI-THROW MICRO-FLUIDIC DEVICES”.

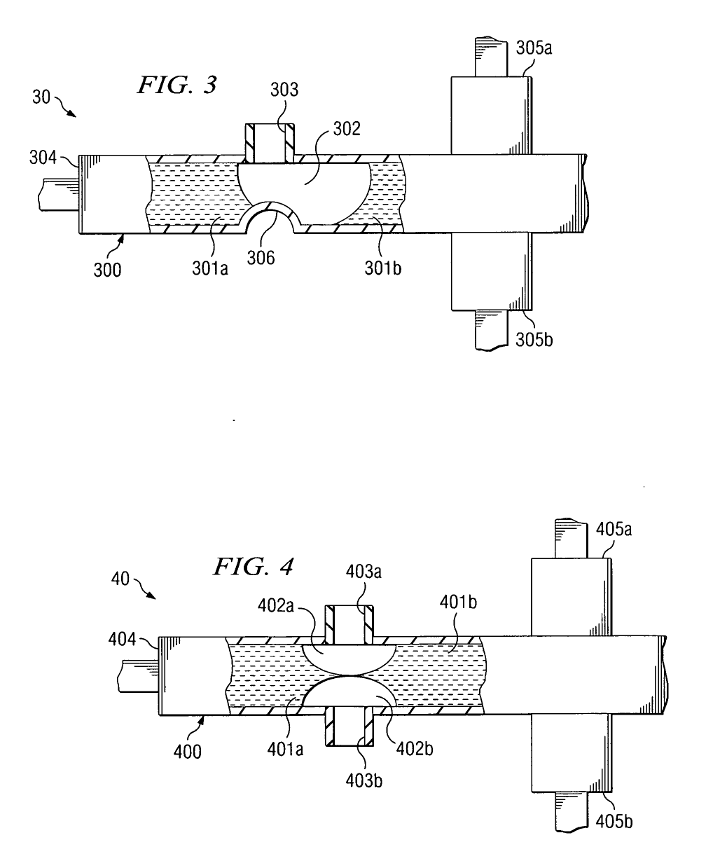

FIG. 3 shows LIMMS device 30, arranged according to an embodiment of the invention. Device 30 comprises channel 300, inlet 303, and perturbation 306. Electrical contacts may be at end walls 305a, 305b and 304. Switching material 301 is in two volumes, 301a and 301b. Wall perturbation 306, approximately across channel 300 from inlet 303, positively influences how the actuating force 302 acts on the liquid metal, thereby separating volumes 301a and 301b. This perturbation can have any shape or size desired with the goal of narrowing the distance required in the channel to split the liquid into two volumes 301a and 301b.

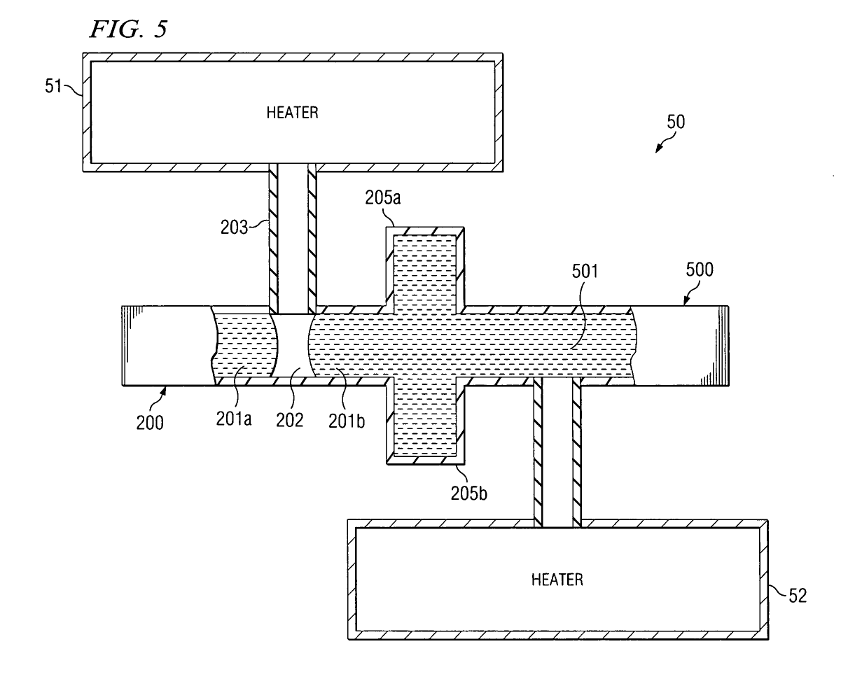

FIG. 4 shows LIMMS device 40, arranged according to an embodiment of the invention. Device 40 comprises channel 400 and inlets 403a and 403b. Electrical contacts may be at end walls 405a, 405b and 404. Switching material 401 is in two volumes, 401a and 401b. Inlets 403a and 403b each provide actuating force, 402a and 402b, respectively. Each actuating force, 402a or 402b, need only work across approximately half the channel in order to fully separate volumes, 401a and 401b.

In situations where the LIMMS device was required to have high-reliability operation, inlets 403a and 403b could provide redundant operation. That is, in normal operation, inlets 403a and 403b would each insert actuating force into channel 400, as described, for example, with respect to FIG. 2. However, if either inlet 403a or 403b failed, such as would occur, for example, if a gas heating element failed, or in the case that the inlets share a heating element and one inlet becomes clogged, then the remaining operational inlet would continue to provide switching capability. Note that the diversion mechanism can either be a structure (of the type shown in FIGS. 2 and 3) or a force (of the type shown in FIG. 4).

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A liquid-based switch comprising:
a channel through which switching material flows;
an inlet to said channel for introducing switching material actuating force into said channel; and
at least one diversion mechanism for influencing movement of said actuating force within said channel.

2. The switch of claim 1 wherein said influencing means comprises:
a least one structural element positioned in said channel.

3. The switch of claim 2 wherein said structural element is positioned in close proximity to said inlet.

4. The switch of claim 1 wherein said influencing means comprises a second inlet positioned in proximity to said inlet.

5. The switch of claim 4 wherein forces applied via both said inlets work in cooperation with each switching material.

6. The switch of claim 1 wherein said movement of said actuating force operates to separate said switching material into separate volumes.

7. The switch of claim 2 wherein said structural element is a protrusion.

8. The switch of claim 6 wherein said protrusion is disposed across said channel from said inlet.

9. The switch of claim 2 wherein said structural element is a second inlet opposing said inlet.

10. The switch of claim 1 further comprising wettable and non-wettable surfaces lining said channel, said non-wettable surfaces positioned in close proximity to said inlet.

11. A method of manufacturing a liquid-based switch comprising:
providing a channel through which switching material flows;
providing for introduction of switching material actuating force into said channel; and
positioning at least one actuating force influencing element with respect to said channel, said influencing element adapted to influence behavior of said actuating force within said channel.

12. The method of claim 11 wherein said providing for introduction of force comprises providing an inlet to said channel.

13. The method of claim 12 wherein said providing for introduction of force further comprises providing a heater operable to heat gas for introduction into said channel.

14. The method of claim 12 wherein said at least one said influencing element is selected from the list of:
a perturbation adjacent to said inlet, a perturbation across said channel from said inlet, a second inlet into said channel.

15. The method of claim 12 further comprising lining at least a portion of said channel with wettable surfaces and lining a portion of said channel in proximity of said inlet with non-wettable surfaces.

16. A method of switching comprising:
joining and separating a first volume of switching material in a channel with a second volume of switching material in said channel using actuating force; and
influencing said actuating force within said channel by interacting said actuating force with an element in addition to said switching material using at least one structural element positioned inside said channel.

17. The method of claim 16 wherein said influencing is by using at least one structural element positioned inside said channel.

18. The method of claim 16 wherein said actuating force is selected from the list of:
gas pressure, electrical force, magnetic force, and compression.

19. The method of claim 17 wherein said gas pressure is introduced into said channel using a gas pressure inlet.

20. The method of claim 16 further comprising:
joining said first volume of switching material with a third volume of switching material in said channel when said first volume is separated from said second volume; and
separating said first volume of switching material from said third volume of switching material when said first volume is joined with said second volume.
